(19) United States
(12) Patent Application Publication
(10) Pub. No.: US 2012/0099144 A1
(43) Pub. Date: Apr. 26, 2012

(54) Image forming apparatus and method for forming an image thereof

(75) Inventors: Yong-geun Kim, Suwon-si (KR); Moo-kyung Sung, Suwon-si (KR)

(73) Assignee: Samsung Electronics Co., Ltd., Suwon-si (KR)

(21) Appl. No.: 13/137,820

(22) Filed: Sep. 14, 2011

(30) Foreign Application Priority Data
Oct. 26, 2010 (KR) 2010-0104655

(51) Int. Cl. G06K 15/00

(52) U.S. Cl. 358/1.15

(57) ABSTRACT

An image forming apparatus and method are provided. The image forming apparatus includes a communication interface unit that receives print data, an image forming unit that forms an image on a print paper, and video controllers that convert received print data into data processable by the image forming unit. The image forming apparatus includes a selection unit that selects one video controller from among the video controllers, and a control unit that controls the selection unit to selectively provide the received print data to one of the video controllers so that the received print data is processed in the video controllers in parallel by job or page.

### CROSS-REFERENCE TO RELATED APPLICATIONS

This application is related to and claims priority to Korean Patent Application No. 2010-0104655, filed in the Korean Intellectual Property Office on Oct. 26, 2010, the disclosure of which is incorporated herein by reference.

### BACKGROUND

1. Field

The embodiments discussed herein are related to an image forming apparatus and a method for forming an image thereof, and more particularly, to an image forming apparatus that is capable of performing high-speed printing using a plurality of video controllers and a method for forming an image thereof.

2. Description of the Related Art

Generally, an image forming apparatus prints data generated by a terminal such as a computer on printing paper. Examples of an image forming apparatus include a copy machine, a printer, a fax machine, and a Multi-Function Peripheral (MFP) that performs multiple functions in a single device.

An image forming apparatus may provide various functions including not only remote-controlling, charging, and authentication, but also high-resolution printing and high-speed printing of more than 40 ppm per minute.

The printing speed of an image forming apparatus may be affected by a printing engine speed and the data processing speed of a video controller that provides necessary image data to the printing engine. Even though a printing engine may support printing of 50 ppm per minute, if a video controller providing necessary image data to the printing engine is not capable of providing image data with more than 50 ppm per minute, the image forming apparatus would not be able to perform printing of more than 50 ppm per minute.

Accordingly, high-speed printing requires that an image forming apparatus have a video controller that can handle the speed of a printing engine. However, support of high-speed data processing of all print data using only one video controller is difficult.

### SUMMARY

An aspect of the exemplary embodiments discussed herein relate to an image forming apparatus that is capable of performing high-speed printing using a plurality of video controllers and a method for forming an image thereof.

An image forming apparatus, according to an exemplary embodiment of the present invention, includes a communication interface unit that receives print data, an image forming unit that forms an image on a print paper, a plurality of video controllers that convert each of the received print data into a data processable by the image forming unit, a selection unit that selects one video controller from among the plurality of video controllers, and a control unit that controls the selection unit to selectively provide the received print data to one of the plurality of video controllers so that the received print data is processed in the plurality of video controllers in parallel by job or page.

Each of the plurality of video controllers may include a RAM, which stores received print data, a ROM, which stores an emulation program, and a control core, which performs data processing with respect to print data stored in the RAM using an emulation program stored in the ROM.

The video controllers may be configured in a form of a module detachable from the image forming apparatus.

The control unit may control the selection unit to provide the received print data to the plurality of video controllers sequentially according to an order of page or job.

The plurality of video controllers may include a first video controller and a second video controller, and the control unit may control the selection unit to provide the received print data to the first video controller and the second video controller alternately by page or job.

The control unit may provide data processed by the first video controller and the second video controller to the image forming unit in an order of receiving processed data.

Each of the plurality of video controllers may perform a different emulation method, and the control unit may control the selection unit to process the received print data in a video controller, which performs an emulation method corresponding to received print data.

The apparatus may further include an option apparatus, which performs a follow-up operation on the printed paper, and the control unit, if a follow-up operation is requested, may control the selection unit to process a job or a page for which the follow-up operation is requested in a preset video controller.

The option apparatus may be at least one of a mail box, a finisher, and a large-scale tray.

The apparatus may further include a plurality of delivery boxes that correspond to the plurality of video controllers and a delivery unit that discharges a printed paper to the plurality of delivery boxes. The control unit may control the delivery unit to discharge the printed paper to a corresponding delivery box.

A method for forming an image in an image forming apparatus having a plurality of video controllers, according to an exemplary embodiment, includes receiving print data, providing the received print data selectively to one of the plurality of video controllers so that the received print data is processed in parallel in the plurality of video controllers by job or page, processing the print data in the plurality of video controllers individually, and forming an image on a print paper using the processed print data.

The video controller may be configured in a form of a module detachable from the image forming apparatus.

The providing may include providing the received print data to the plurality of video controllers sequentially in an order of page or job.

The plurality of video controllers may include a first video controller and a second video controller, and the providing may include providing the received print data to the first video controller and the second video controller alternately in an order of page or job.

Each of the plurality of video controllers may perform a different emulation method, and the providing may include providing the received print data to one of the plurality of video controllers selectively so that the received print data is processed in a video controller that performs an emulation method corresponding to the received print data.

The providing may include, if the follow-up operation is requested, providing the received print data to one of the plurality of video controllers selectively so that a job or a page for that the follow-up operation is requested in processed in a preset video controller.

### BRIEF DESCRIPTION OF THE DRAWINGS

The above and/or other aspects of the present disclosure will be more apparent from the following detailed description when taken in conjunction with to accompanying drawings, in which:

FIG. 1 illustrates an image forming apparatus according to an exemplary embodiment;

FIG. 2 illustrates operation of an exemplary selection unit;

FIG. 3 illustrates operation of an exemplary selection unit;

FIG. 4 illustrates operation of an exemplary selection unit;

FIG. 5 illustrates operation of an exemplary selection unit; and

FIG. 6 illustrates a method for forming an image according to an exemplary embodiment.

### DETAILED DESCRIPTION

Exemplary embodiments are described in detail below with reference to the accompanying drawings.

These together with other aspects and advantages which will be subsequently apparent, reside in the details of construction and operation as more fully hereinafter described and claimed, reference being had to the accompanying drawings forming a part hereof, wherein like numerals refer to like parts throughout.

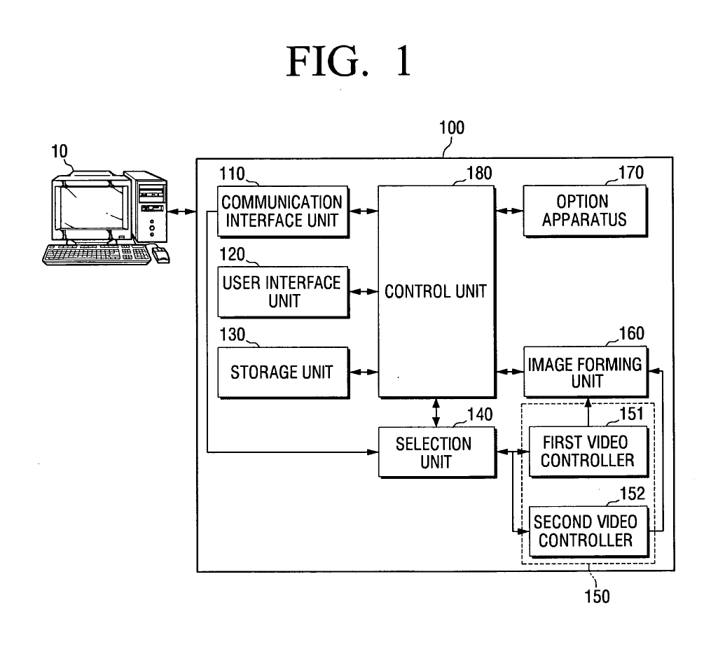

FIG. 1 illustrates an image forming apparatus according to an exemplary embodiment.

Referring to FIG. 1, the image forming apparatus 100 includes a communication interface unit 110, a user interface unit 120, a storage unit 130, a selection unit 140, a plurality of video controllers 150, an image forming unit 160, an option apparatus 170, and a control unit 180.

The communication interface unit 110 may be connected to a print control terminal 10 such as a PC, a PDA, and/or a digital camera. The communication interface unit 110 may be formed to connect the image forming apparatus 100 to an external apparatus and may be connected to the print control terminal 10 via Local Area Network (LAN), an Internet network or using a USB port. In addition, the communication interface unit 110 may have a wired or wireless connection to the print control terminal 10.

The communication interface unit 110 may receive print data from the print control terminal 10. The print data may be a Printer Command Language (PCL), Page Description Language (PDL) language written in a PostScript (PS) language, Graphic Device Interface (GDI) data, and an XPS file generated by a printer driver of the print control terminal 10. In an exemplary embodiment, print data may be received from the print control terminal 10, but this is only an example. A file may be directly transmitted to an image forming apparatus.

The user interface unit 120 has a plurality of function keys through which a user may set or select various functions supported by the image forming apparatus 100. The user interface unit 120 may be embodied as a touch pad that may perform input and output simultaneously, or as an apparatus that combines a mouse and a monitor. A user may select an operation to be performed using a user interface window provided by the user interface unit 120.

The storage unit 130 stores print data. The storage unit 130 stores print data received through the communication interface unit 110. In addition, the storage unit 130 may store data processed by a plurality of video controllers 150 that will be explained later. The storage unit 130 may be embodied as a storing medium in the image forming apparatus 100 or as an external storing medium such as a removable disk including a USB memory or a web server through a network. In the illustrated exemplary embodiment, only one storage unit 130 is illustrated, but this is only an example. The storage unit 130 may be divided into a memory for storing data and a memory for processing a command.

The selection unit 140 may select a video controller from among a plurality of video controllers. The selection unit 140 may categorize print data received from the communication interface unit 110 or print data stored in the storage unit 130 according to job or page, and provide the print data to the plurality of video controllers 150 selectively based on the categorization.

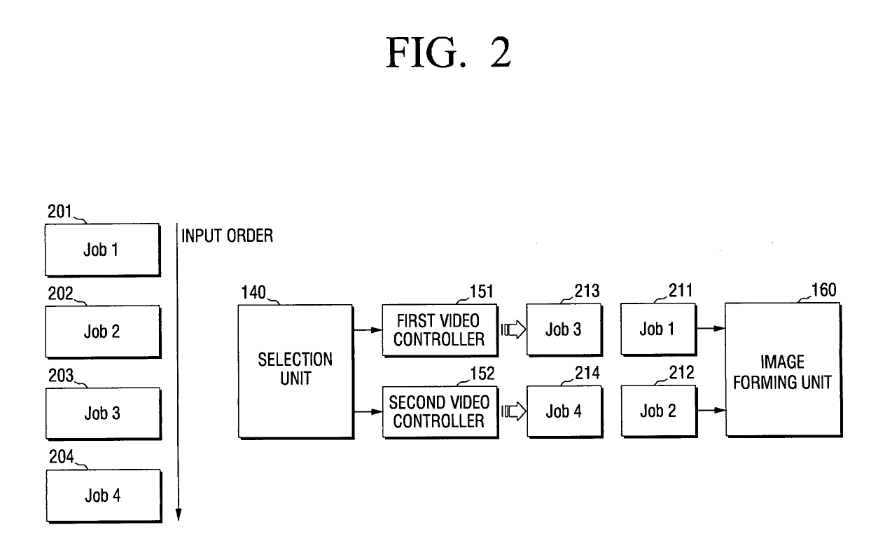

In an exemplary embodiment, the selection unit 140 categorizes print data received from the communication interface unit 110 or print data stored in the storage unit 130 according to job or page autonomously, but the operation may be performed according to control of the control unit 180. In addition, one of the plurality of video controllers 150 may operate as a master video controller, and the master video controller may control the selection unit 140. Operation of an exemplary selection unit 140 is illustrated in FIGS. 2 to 5.

The plurality of video controllers 150 may convert received print data into data recognizable by the image forming unit 160. Each of the plurality of video controllers 150 has a RAM for storing received print data, a ROM for storing an emulation program, and a control core for performing data-processing on print data stored in the RAM using the emulation program stored in the ROM. In addition, each of the plurality of video controllers 150 performs rendering and binarization on print data provided through the selection unit to convert the print data into data that can be processed by the image forming unit 160. Hereinafter, it will be assumed that the plurality of video controllers 150 are embodied as a first video controller 151 and a second video controller 152 for convenience of explanation.

Each of the video controllers 150 may be operated independently and be configured as a module that can be separated from the image forming apparatus 100. Accordingly, a user may add a video controller to an image forming apparatus having only one video controller 151 so as to realize the image forming apparatus 100 as in the exemplary embodiment. In addition, as illustrated in FIG. 1, a video controller module may be added to the image forming apparatus 100 so that an image forming apparatus may have, for example, three video controllers.

The image forming unit 160 forms an image using data processed by the plurality of video controllers 150. The image forming unit 160 may form an image on a print paper using data provided by the plurality of video controllers 150. As such, the image forming unit 160 provides data from the plurality of video controllers 150 and thus, a reduced speed in one video controller does not affect the speed of the image forming unit 160 significantly.

The option apparatus 170 performs a follow-up operation, for example, on a printed paper. The option apparatus 170 performs the operations of categorizing printed papers, stapling the categorized printed papers, and storing a large amount of printed papers. The option apparatus may be a mail box, finisher, or a high capacity feeder (HCF). The mail box may include a plurality of delivery boxes and a delivery unit that delivers printed papers to one of the plurality of delivery boxes. Each of the plurality of delivery boxes may correspond to one of the plurality of video controllers. For example, print output of print data processed by the first video controller 151 may be discharged from a first delivery box, and print output of print data processed by the second video controller 152 may be discharged from a second delivery box.

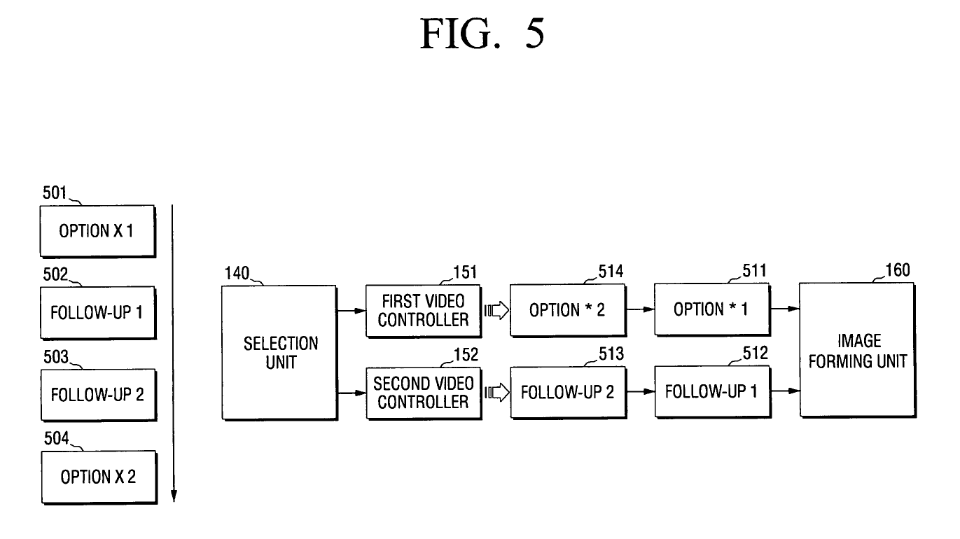

If the image forming apparatus 100 is connected to the option apparatus 170, an operation of the option apparatus may slow down a printing speed. For example, if the option apparatus is a finisher and the speed of the finisher is 30 ppm, the control unit 180 may control a job or a page according to whether an stapling option is set with respect to print data so that a job or a page for that an stapling option is not set can be processed by the first controller 151 and a job or a page for that an stapling operation is set can be processed by the second video controller 152. An exemplary embodiment is illustrated in FIG. 5.

The control unit 180 may control each configuration of the image forming apparatus 100. If print data is received from the print control terminal 10, the control unit 180 may control the selection unit 140 to provide received print data selectively to one of the plurality of video controllers so that the received print data can be processed in the plurality of video controller in parallel by job or page.

The image forming apparatus 100 according to the exemplary embodiment performs data conversion using a plurality of video controllers and thus, slowdown of speed that may occur while processing print data into image data may be prevented.

FIGS. 2 to 5 illustrate exemplary operations of an exemplary control unit.

FIG. 2 illustrates a plurality of jobs 201, 202, 203, 204 sequentially input to the selection unit 140.

The control unit 180 controls the selection unit 140 so as to provide the plurality of jobs 201, 202, 203, 204 to the first video controller 151 and the second video controller 152 alternately. Thus, the selection unit 140 may provide the plurality of jobs 201, 202, 203, 204, which are input to the selection unit 140 sequentially, to the first video controller 151 and the second video controller 152 alternately.

Accordingly, the first video controller 151 may process the jobs 201, 203 and provide data 211, 213, which can be recognized by the image forming unit 160 to the image forming unit 160. The second video controller 152 may process the jobs 202, 204 and provide data 212, 214, which can be recognized by the image forming unit 160 to the image forming unit 160.

Data output from the first video controller 151 and the second video controller 152 may be provided to the image forming unit 160 in the same order that it is input to the selection unit 140. That is, data output from the first video controller 151 and the second video controller 152 may be provided to the image forming unit 160 in the order of 211, 212, 213, and 214.

In FIG. 2, only two video controllers are illustrated for convenience of explanation, but print data may be provided to a greater number, e.g., more than three video controllers sequentially by job according to the job order.

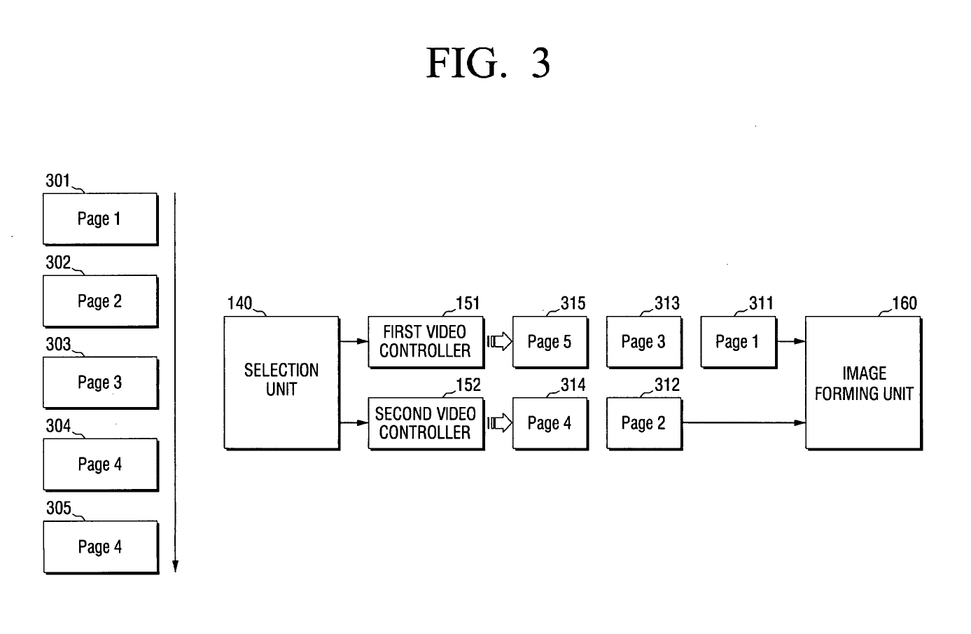

FIG. 3 illustrates a plurality of pages 301, 302, 303, 304, 305 sequentially input to the selection unit 140.

A control unit, e.g., control unit 180 controls the selection unit 140 to provide the plurality of pages 301, 302, 303, 304, 305 to the first video controller 151 and the second video controller 152 alternately and thus, the selection unit 140 may provide the plurality of pages 301, 302, 303, 304, 305, which are input to the selection unit 140 sequentially, to the first video controller 151 and the second video controller 152 alternately.

Accordingly, the first video controller 151 may process a plurality of pages 301, 303, 305 and provide a plurality of data 311, 313, 315 that can be recognized by the image forming unit 160 to the image forming unit 160. Likewise, the second video controller 152 may process a plurality of pages 302, 304 and provide a plurality of data 312, 314 that can be recognized by the image forming unit 160.

Data output from the first video controller 151 and the second video controller 152 may be provided to the image forming unit 160 in the same order that it is input to the selection unit 140. That is, data output from the first video controller 151 and the second video controller 152 may be provided to the image forming unit 160 in the order of 311, 312, 313, 314, and 315.

FIG. 3 illustrates only two video controllers for convenience of explanation, but print data may be provided to a greater number, e.g., more than three video controllers by page sequentially.

In FIGS. 2 and 3, it is assumed that the first video controller and the second video controller have similar functions and performances, but the first video controller and the second video controller may, have different functions from each other.

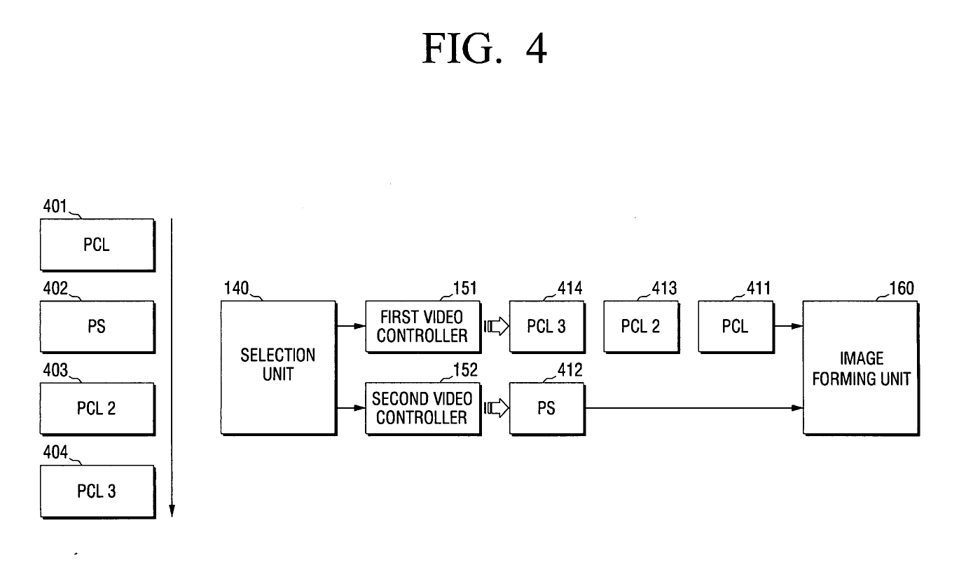

FIG. 4 illustrates a plurality of jobs 401, 402, 403, 404 having a different print language input to the selection unit 140 sequentially. The first video controller 151 may support a PCL emulation method, and the second video controller 152 may support a PS emulation method.

A control unit, e.g., control unit 180 controls the selection unit 140 so that the plurality of jobs 401, 402, 403, 404 can be processed in a video controller that performs an emulation method corresponding to received print data. Thus, the selection unit 140 may provide the plurality of jobs 401, 403, 404 having a PCL print language to the first video controller 151 and the job 402 having a PS print language to the second video controller 152 that supports a PS emulation.

Accordingly, the first video controller 151 may process the plurality of jobs 401, 403, 404 using a PCL emulation method and provide a plurality of processed data 411, 413, 414 to the image forming unit 160. Likewise, the second video controller 152 may process the job 402 using a PC emulation method and provide processed data 412 to the image forming unit 160.

Data output from the first video controller 151 and the second video controller 152 may be provided to the image forming unit 160 in the same order that it is input to the selection unit 140. That is, data output from the first video controller 151 and the second video controller 152 may be provided to the image forming unit 160 in the order of 411, 412, 413, and 414.

In referring to FIG. 4, only a case where the first video controller 151 and the second video controller 152 have a different emulation method from each other has been discussed, but the first video controller 151 and the second video controller 152 may also be embodied to have a different processing time and a different priority from each other. If a plurality of controllers are embodied to have a different processing time and a different priority from one another, the control unit 180 may control the video controllers to perform processing according to a preset condition or a processing time and a priority that are different depending on each user.

FIG. 5 illustrates a plurality of jobs 501, 502, 503, 504 input to the selection unit 140 sequentially. According to an exemplary embodiment, —it may be—assumed that the second video controller 152 is a video controller that is preset to perform a job requiring a follow-up operation.

If a follow-up operation is requested, a control unit, e.g.,—control unit 180 controls the selection unit 140 to process a job or a page for which a follow-up job is requested in a preset video controller. Thus, the selection unit 140 may provide the jobs 501, 504 for which a follow-up job is not requested to the first video controller 151, and the jobs 502, 503 for which a follow-up job is requested to the second video controller 152 that is a preset video controller.

Accordingly, the first video controller 151 may process the plurality of jobs 501, 504 and provide a plurality of data 511, 514 that can be recognized by the image forming unit 160 to the image forming unit 160. Likewise, the second video controller 152 may process the plurality of jobs 502, 503 and provide a plurality of data 512, 513 that can be recognized by the image forming unit 160 to the image forming unit 160.

In this case, data output from the first video controller 151 and the second video controller 152 may be provided to the image forming unit 160 in the same order that it is input to the selection unit 140. Alternatively, a job or a page for which a follow-up operation is requested may be provided to the image forming unit 160 later than a job or a page for which a follow-up operation is not requested.

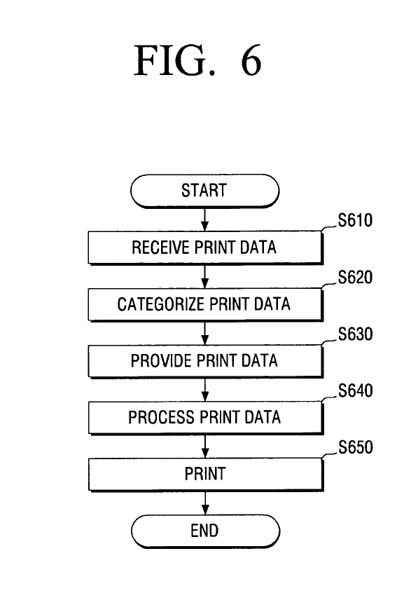

FIG. 6 illustrates a method for forming an image according to an exemplary embodiment.

Referring to FIG. 6, if print data is received (S610), the print data may be categorized by a job or a page so that the received print data may be processed in parallel in a plurality of video controllers (S620).

Received print data may be categorized in the order of page or job so that the print data is provided to a plurality video controllers sequentially. If a plurality of video controllers operate according to a different emulation method, received print data may be categorized so that the print data is processed in a video controller that performs an emulation method corresponding to the received print data. In addition, if an option for performing a follow-up operation is set with respect to print data, the print data may be categorized so that a job or a page for which a follow-up operation is set is processed in a preset video controller.

Each of the categorized print data may be provided to a corresponding video controller (S630), and the video controller may process the received print data (S640). Data that can be processed by an image forming unit may be generated by rendering the transmitted print data into a bitmap image and performing half-toning and binarization on the rendered bitmap image.

The converted print data may be provided to the image forming unit 160, and a print operation may be performed by the image forming unit 160 (S650). If an option for using an option apparatus is set with respect to print data, a follow-up operation may be performed for a printed paper.

Therefore, the image forming method according to the exemplary embodiment performs print data processing in a plurality of video controllers and thus, a slow down of printing speed that may occur during a data processing process may be avoided. The image forming method illustrated in FIG. 6 may be performed not only in an image forming apparatus having the configuration illustrated in FIG. 1, but also on an image forming apparatus having other configuration.

Further, according to an aspect of the embodiments, any combinations of the described features, functions and/or operations can be provided. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An image forming apparatus, comprising:
a communication interface unit that receives print data;
an image forming unit that forms an image on a print paper;
a plurality of video controllers that convert each of the received print data into a data processable by the image forming unit;
a selection unit that selects one video controller from among the plurality of video controllers; and
a control unit that controls the selection unit to selectively provide the received print data to one of the plurality of video controllers so that the received print data is processed in the plurality of video controllers in parallel by job or page.

2. The apparatus as claimed in claim 1, wherein each of the plurality of video controllers comprises:
a RAM that stores received print data;
a ROM that stores an emulation program; and
a control core that performs data processing with respect to print data stored in the RAM using an emulation program stored in the ROM.

3. The apparatus as claimed in claim 2, wherein the video controllers are configured in a form of a module detachable from the image forming apparatus.

4. The apparatus as claimed in claim 1, wherein the control unit controls the selection unit to provide the received print data to the plurality of video controllers sequentially according to an order of page or job.

5. The apparatus as claimed in claim 1, wherein the plurality of video controllers comprise:
a first video controller; and
a second video controller,
wherein the control unit controls the selection unit to provide the received print data to the first video controller and the second video controller alternately by page or job.

6. The apparatus as claimed in claim 5, wherein the control unit provides data processed by the first video controller and the second video controller to the image forming unit in an order of receiving processed data.

7. The apparatus as claimed in claim 1, wherein each of the plurality of video controllers performs a different emulation method,
wherein the control unit controls the selection unit to process the received print data in a video controller that performs an emulation method corresponding to received print data.

8. The apparatus as claimed in claim 1, further comprising:
an option apparatus that performs a follow-up operation on the printed paper,
wherein the control unit, if a follow-up operation is requested, controls the selection unit to process a job or a page for which the follow-up operation is requested in a preset video controller.

9. The apparatus as claimed in claim 7, wherein the option apparatus is at least one of a mail box, a finisher, and a large-scale tray.

10. The apparatus as claimed in claim 1, further comprising:
a plurality of delivery boxes that correspond to the plurality of video controllers; and
a delivery unit that discharges a printed paper to the plurality of delivery boxes,
wherein the control unit controls the delivery unit to discharge the printed paper to a corresponding delivery box.

11. A method for forming an image in an image forming apparatus having a plurality of video controllers, the method comprising:
receiving print data;
providing the received print data selectively to one of the plurality of video controllers so that the received print data is processed in parallel in the plurality of video controllers by job or page;
processing the print data in the plurality of video controllers individually; and
forming an image on a print paper using the processed print data.

12. The method as claimed in claim 11, wherein the video controller is configured in a form of a module detachable from the image forming apparatus.

13. The method as claimed in claim 11, wherein the providing comprises providing the received print data to the plurality of video controllers sequentially in an order of page or job.

14. The method as claimed in claim 14, wherein the plurality of video controllers includes a first video controller and a second video controller,
wherein the providing comprises providing the received print data to the first video controller and the second video controller alternately in an order of page or job.

15. The method as claimed in claim 11, wherein each of the plurality of video controllers performs a different emulation method,
wherein the providing comprises providing the received print data to one of the plurality of video controllers selectively so that the received print data is processed in a video controller that performs an emulation method corresponding to the received print data.

16. The method as claimed in claim 11, wherein the providing comprises, if the follow-up operation is requested, providing the received print data to one of the plurality of video controllers selectively so that a job or a page for which the follow-up operation is requested in processed in a preset video controller.

17. An image forming apparatus, comprising:
a first video controller to process a first plurality of jobs; and
a second video controller to process a second plurality of jobs,
wherein the first video controller and the second video controller have a least one of a different emulation method, a different processing time and a different priority from each other.

18. The apparatus according to claim 17, further comprising a control unit to control a processing by at least one of the first and second video controllers according to a preset condition.

19. The apparatus of claim 17, further comprising a control unit to control a processing time that is dependent on an identity of a user.

20. The apparatus according to claim 17, wherein the priority is different for different users.
